(19) United States
(12) Patent Application Publication
(10) Pub. No.: US 2007/0045416 A1
(43) Pub. Date: Mar. 1, 2007

(54) Mapping Between URI and ID Service Guide

(75) Inventors: Toni Paila, Degerby (FI); Martta Seppala, San Diego, CA (US)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/467,003

(22) Filed: Aug. 24, 2006

Related U.S. Application Data
(60) Provisional application No. 60/710,606, filed on Aug. 24, 2005.

(51) Int. Cl. G06K 7/00

(52) U.S. Cl. 235/435

(57) ABSTRACT

Embodiments of the invention are directed to transmitting and receiving electronic service guide (“ESG”) fragments. In the transmission of ESG fragments, the identifier (“ID”), version, and/or uniform resource identifier (“URI”) values associated with the ESG fragments for transmission are processed and compared. The ESG fragments are encapsulated in a service guide delivery unit (“SGDU”) based on the processing and comparison of the values. Likewise, an SGDU can be received at a receiver, data pertaining to the ID, version, and/or URI values of the SGDU and associated ESG fragments may be extracted and compared to previously stored values. The SGDU and ESG fragments may then be processed in accordance with the comparison results.

### CROSS REFERENCE TO RELATED APPLICATIONS

This application claims the benefit of U.S. Provisional Application No. 60/710,606, which was filed Aug. 24, 2005, and which is incorporated herein by reference.

### TECHNICAL FIELD

Embodiments of the invention relate generally to communications networks. More specifically, embodiments of the invention relate to Electronic Service Guides that are used in communication networks.

### BACKGROUND

Generally, an Electronic Service Guide (ESG) enables a terminal to communicate what services are available to end users and how the services may be accessed. ESG fragments are independently existing pieces of the ESG. Traditionally, ESG fragments comprise XML documents, but more recently they have encompassed a vast array of items, such as for example, an SDP (Session Description Protocol) description, textual file, or an image. The ESG fragments describe one or several aspects of currently available (or future) service or broadcast programs. Such aspects may include for example: free text description, schedule, geographical availability, price, purchase method, genre, and supplementary information such as preview images or clips. Audio, video and other types of data comprising the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). ESG fragments may also be transmitted by using ALC and FLUTE protocols. Data is often transmitted through the Internet addressed to a single user. It can, however, be addressed to a group of users, commonly known as multicasting. In the case in which the data is addressed to all users it is called broadcasting.

ESG fragments include metadata and descriptions of services or content and are instantiated using a syntax such as XML. Identifiers are used to identify the ESG fragments regarding various attributes of the ESG fragments. However, these identifiers often create large overhead due to their large size. For example, if a Uniform Resource Identifier (URI) is used as an identifier, the overhead is large and unwieldy at 255*8. Therefore, short 32-bit integer identifiers have been used to identify ESG fragments. However, identifiers must be unique for each corresponding ESG fragment. Administration of 32-bit integer identifiers would need to be globally centralized in order to provide the necessary uniqueness of the identifier because ESG fragments from different sources may be identified by non-unique identifiers. For example, as ESG fragments are often aggregated from different sources, each source may not use a standard identifier scheme such that there may be conflicts of identifiers among different sources. In this example, different sources may use the same identifier for corresponding ESG fragments from the different sources. When the different ESG fragments from different source with the same identifier are received at the aggregator, conflicts will arise.

Thus, there exists a need for a method and system for uniquely identifying ESG fragments in an efficient manner with low overhead.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example of the present invention, a transmitter for transmitting ESG fragments includes a memory for storing data associated with an ESG fragment, an input for receiving an ESG fragment for transmission, the ESG fragment for transmission having a corresponding ID and version, a data comparator for comparing data pertaining to ESG fragments, an aggregator for creating a Service Guide Delivery Unit (SGDU) associated with the ESG fragment for transmission and an encapsulator for encapsulating the ESG fragment for transmission in the SGDU.

In another example of the present invention, a receiver is provided for receiving an SGDU associated with at least one ESG fragment comprising a memory for storing data associated with an ESG fragment, an input for receiving the SGDU associated with at least one ESG fragment, a data extractor for extracting data associated with the at least one ESG fragment, and a comparator for comparing the extracted data with corresponding values associated with the data stored in memory.

In another example, a method for transmitting an ESG fragment is provided wherein an ESG fragment is received and the URI associated with the ESG fragment is compared with a list of at least one stored URI. An ID and a version of the ESG fragment is assigned based on the comparing, and an SGDU is created based on the assigned ID and version.

In another example of the present invention, a method for transmitting an ESG fragment in which an ESG fragment is received and the URI of the ESG fragment is compared with a list of at least one stored URI. An ID and version of the ESG fragment is assigned based on the comparing step and an SGDU is created.

In another example, a method for receiving an SGDU is provided wherein an SGDU is received including at least one ESG fragment and ID and version information is extracted and compared to stored information. Also, URI information can be extracted from the SGDU and compared to stored URI information, and ESG fragment processing can be performed based on the comparisons.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a wireless communication system in which various aspects of the present invention may be implemented.

FIG. 2 illustrates a block diagram of a mobile terminal in accordance with an aspect of the present invention.

FIG. 3 illustrates a schematic diagram of an example transport object in accordance with an aspect of the present invention.

FIG. 4 is a block diagram illustrating an example of a service guide delivery descriptor (“SGDD”) in which one or more illustrative embodiments of the invention may be implemented.

FIG. 5 is a block diagram illustrating an example of declaring fragments and their availability in which one or more illustrative embodiments of the invention may be implemented.

FIG. 6 is a block diagram illustrating an example of a transmitter in which one or more illustrative embodiments of the invention may be implemented.

FIG. 7 is a block diagram illustrating an example of a receiver in which one or more illustrative embodiments of the invention may be implemented.

FIG. 8 is a flowchart illustrating an example of a method for processing ESG fragments for transmission in which one or more illustrative embodiments of the invention may be implemented.

FIG. 9 is a flowchart illustrating an example of a method for processing ESG fragments containing version information for transmission in which one or more illustrative embodiments of the invention may be implemented.

FIG. 10 is a flowchart illustrating an example of a method for receiving and processing an SGDU associated with at least one ESG fragment in which one or more illustrative embodiments of the invention may be implemented.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

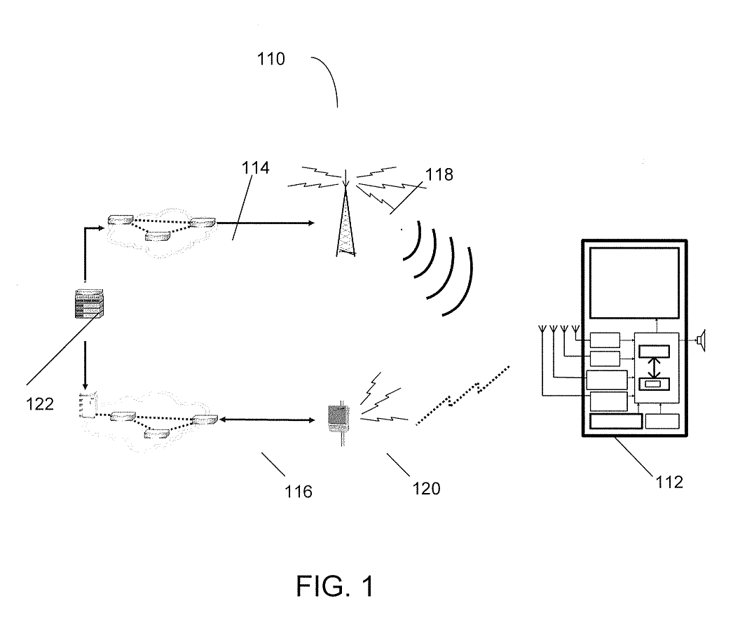

Embodiments of the invention may be utilized across a broad array of networks and communication protocols. FIG. 1 illustrates an example of a wireless communication system 110 in which the systems and methods of the invention may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, AM/FM radio service providers, SMS/MMS push service providers, Internet content or access providers.

The broadcast network 114 may include a radio transmission of IP datacasting over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

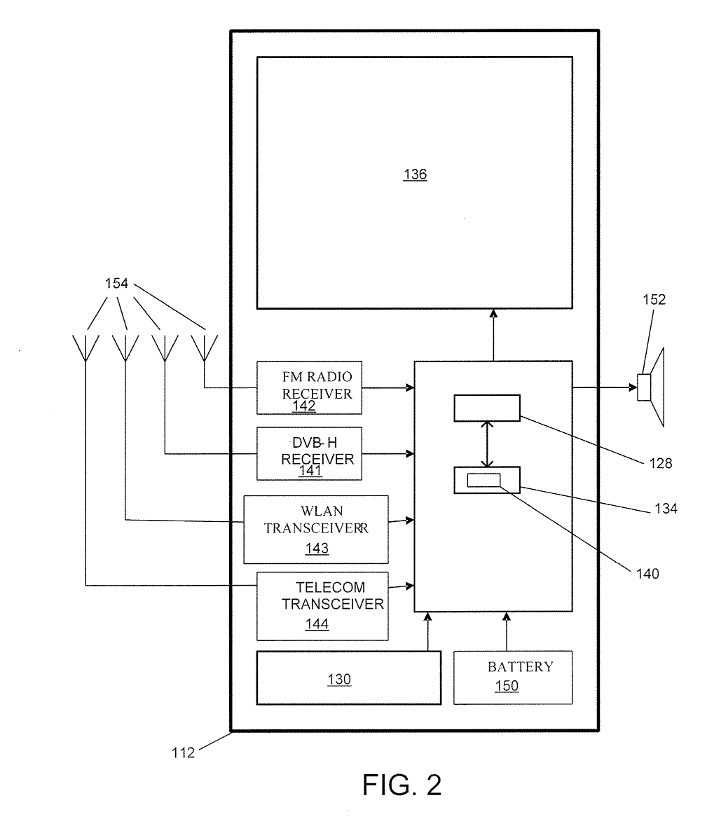

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, four arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory, wherein some of the memory modules may be detachable. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process transmissions based on the Digital Video Broadcast (DVB) standard, such as DVB-H or DVB-MHP, through a specific DVB receiver 141. Additionally, receiver device 112 may also be configured to receive, decode and process transmissions through FM/AM Radio receiver 142, WLAN transceiver 143, and telecommunications transceiver 144. Further the mobile device may be configured to receive transmissions based on the Digital Audio Broadcasting (DAB) standard (not shown). In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting) or DIRECTV. Additionally, the digital transmission may be time sliced, such as in DVB-H technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

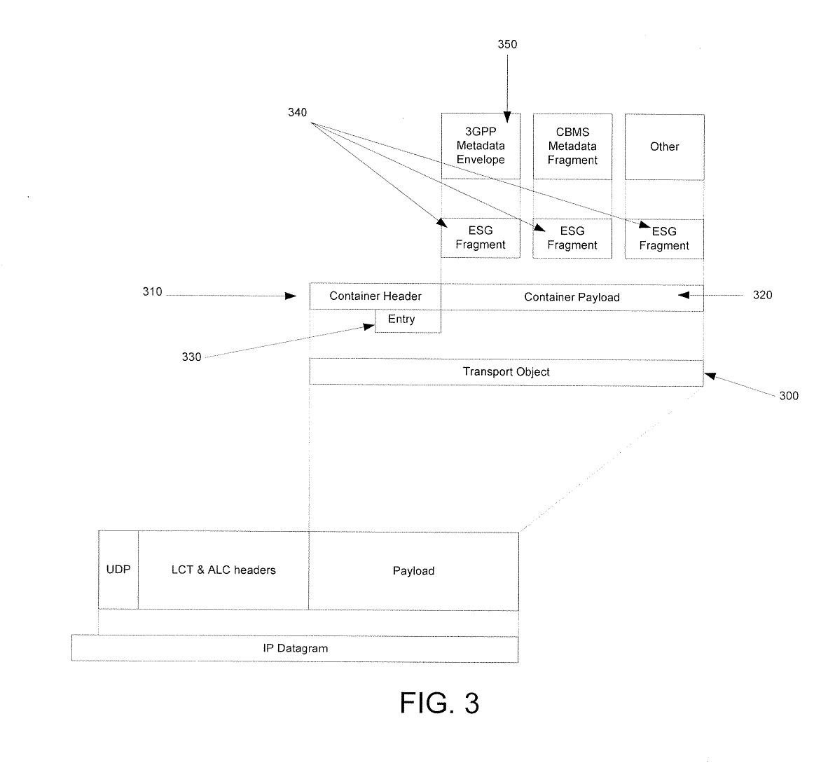

FIG. 3 is a schematic diagram of an example transport object in accordance with at least one aspect of the present invention. Generally, a single transport object 300 comprises a container header 310 and a container payload 320. By incorporating the header 310 and the payload 320 into a single transport object 300, there is no longer a need to recombine each header with the information regarding where each container is located within different transported objects. Furthermore, there is no longer an issue of which to transmit first, as presented in previous systems. The container header 310 may contain configuration information regarding the header and/or the container payload 320. In one embodiment, the header 310 is coded to inform a receiver of the entry length of the header.

In the exemplary embodiment, the header 310 may have a plurality of ESG fragment descriptor entries 330 that identify the ESG fragments 340 in the container payload 320 so that the receiver may determine the exact position and/or length of each contained ESG fragment 340. For example, in one embodiment, a field specifies where the particular ESG begins within the container payload 320 by providing, for example, an offset value, start and end points, or the like. In other embodiments, metadata 350 may be associated with the individual ESG fragments 340, located within or proximate to the header 310, descriptor entries 330, a ESG fragment 340 or a mixture thereof. In one exemplary embodiment, the association of a 3GPP metadata envelope with an ESG fragment 340 may substitute for, or negate the need of additional metadata to be located in the header 310 in relation to that particular ESG fragment.

The ESG fragments can be identified and described by descriptors such as Service Guide Delivery Descriptors (SGDD). SGDDs carry information on various attributes of ESG fragments such as the availability or validity of the ESG fragments. Hence, the SGDD contains data that can be used to retrieve the associated ESG fragments. ESG fragments may also be grouped together and identified as a group by a Service Guide Delivery Unit (SGDU).

An SGDD can be used, for example, to specify criteria for grouping ESG fragments in a service guide in an SGDU. Grouping of ESG fragments can be made based on a variety of criteria such as but not limited to based on time. For example, ESG fragments corresponding to a particular period of time may be grouped together in a subgroup and identified by a corresponding SGDD. As another example, ESG fragments may be grouped based on content such as content type (e.g., comedy, action, drama, etc.). These ESG fragments may also be grouped together and identified by a corresponding SGDD.

An SGDD can also specify a pointer to a transport session for delivering corresponding ESG fragments within a SGDU. For example, an SGDD can identify the transport session based on criteria such as a destination IP address of a target delivery session, the destination port of a target delivery session, the source IP address of the delivery session, or an identifier of the target delivery session. The following table lists examples of subelements and attributes of the SGDD.

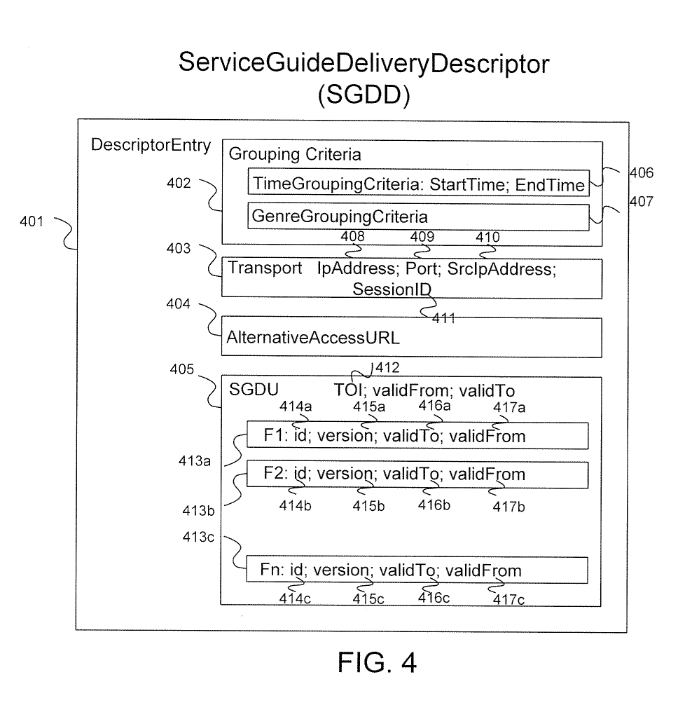

TABLE

| Name | Type | Category | Cardinality | Description | Data type |
|---|---|---|---|---|---|
| ServiceGuideDelivery | E | M | 1..N | The Service Guide Delivery | |
| Descriptor | | | | Descriptor Contains the | |
| | | | | following sub-element: | |
| | | | | DescriptorEntry | |
| DescriptorEntry | E1 | M | 1..N | Contains: | |
| | | | | GroupingCriteria | |
| | | | | Transport | |
| | | | | AlternativeAccessURL | |
| | | | | ServiceGuideDeliveryUnit | |
| GroupingCriteria | E2 | O | 0..1 | Specifies criteria for | |
| | | | | grouping of ESG | |
| | | | | fragments | |
| | | | | Contains: | |
| | | | | TimeGroupingCriteria | |
| | | | | GenreGroupingCriteria | |
| TimeGroupingCriteria | E3 | O | 0..1 | Specifies period of time | |
| | | | | the DescriptorEntry | |
| | | | | describes | |
| | | | | Contins: | |
| | | | | StartTime | |
| | | | | EndTime | |
| StartTime | A | M | 1 | Start of the time period | NTP time as |
| | | | | this DescriptorEntry | unsignedInt |
| | | | | declares ESG fragments for | (32 bits) |
| EndTime | A | M | 1 | End of the time period | NTP time as |
| | | | | this DescriptorEntry | unsignedInt |
| | | | | declares fragments for | (32 bits) |
| GenreGroupingCriteria | E3 | O | 0..1 | Specifies classification | Integer |
| | | | | of services/content | |
| | | | | associated with ESG | |
| | | | | fragments in this SGDU | |
| Transport | E2 | O | 0..1 | Pointer to the transport | |
| | | | | session delivering the | |
| | | | | ESG fragments within | |
| | | | | SGDU announced in this | |
| | | | | Descriptor Entry | |
| | | | | Contains: | |
| | | | | IpAddress | |
| | | | | Port | |
| | | | | SrclpAddress | |
| | | | | SessionID | |
| IpAddress | A | M | 1 | Destination IP address | String |
| | | | | of target delivery session | |
| Port | A | M | 1 | Destination port of target | unsignedShort |
| | | | | delivery session | (16 bits) |
| SrclpAddress | A | O | 0..1 | Source IP address of the | String |
| | | | | delivery session | |
| SessionID | A | M | 1 | Identifier of target | unsignedShort |
| | | | | delivery session | (16 bits) |
| AlternativeAccessURL | E2 | O | 0..N | Alternative URL for | AnyURI |
| | | | | retrieving the SGDUs | |
| | | | | via the interaction | |
| | | | | channel | |
| ServiceGuideDeliveryUnit | E2 | M | 1..N | Group of fragments | |
| | | | | Contains: | |
| | | | | transportObjectID | |
| | | | | validFrom | |
| | | | | validTo | |
| | | | | Contains Fragment sub-element | |
| transportObjectID | A | O | 0..1 | Transport object ID of the | unsignedInt |
| | | | | SGDU carrying the declared | (32 bits) |
| | | | | fragments within this | |
| | | | | FragmentGroup | |
| validFrom | A | O | 0..1 | First moment of time | NTP time as |
| | | | | this group of ESG | unsignedInt |
| | | | | fragments is valid. | (32 bits) |
| validTo | A | O | 0..1 | Last moment of time this | NTP time as |
| | | | | group of ESG fragments is | unsignedInt |
| | | | | valid | (32 bits) |
| Fragment | E3 | M | 1..N | Declaration of ESG fragment | |
| | | | | available over broadcast | |
| | | | | channel | |
| | | | | Contains: | |
| | | | | id | |
| | | | | version | |
| | | | | validFrom | |
| | | | | validTo | |
| | | | | Type | |
| Id | A | M | 1 | Identifier of the announced | unsignedInt |
| | | | | ESG fragment | |
| Version | A | M | 1 | Version of the announced | unsignedByte |
| | | | | ESG fragment | (8 bits) |
| validFrom | A | O | 0..1 | First moment when fragment | NTP time as |
| | | | | is valid. | unsignedInt |
| | | | | | (32 bits) |
| validTo | A | O | 0..1 | Last moment when this | NTP time as |
| | | | | fragment is valid | unsignedInt |
| | | | | | (32 bits) |
| Type | A | M | 1 | Enumeration value | unsignedInt |
| | | | | designating schema or MIME | (32 bits) |
| | | | | type for fragment | |

Where the type can be an Element (E), an Attribute (A), a first level sub-element (E1), or a second level sub-element (E2) and the category can be optional (O) or preferred/mandatory (M). FIG. 4 is a block diagram illustrating an example of an SGDD providing a description of a corresponding one or more ESG fragments. In this example, DescriptorEntry 401 in the SGDD contains subelements GroupingCriteria 402, Transport 403, AlternativeAccessURL 404 and SGDU 405. GroupingCriteria 402 contains subelements TimeGroupingCriteria 406 (including attributes StartTime and EndTime) and GenreGrouping Criteria 407. Transport 403 contains attributes IpAddress 408, Port 409, SrcIpAddress 410, and SessionID 411. SGDU 405 contains attribute TOI 412 which indicates which Transport Object the ESG fragments are transported in. Each of the ESG fragments 413a-c (F1, F2, . . . Fn, in this example) are indicated in the SGDU 405 which also indicates attributes such as an ID 414a-c of a corresponding ESG fragment (e.g., id or frag_id), version 415a-c of the ESG fragment (e.g., version or frag_version), validTo 416a-c and validFrom 417a-c of the ESG fragment.

In this example, a group of ESG fragments 413 is sent to a receiver within a transport object. The transport object is identified by the attribute TOI 412 in subelement SGDU 405 and the transport attributes (408, 409, 410, 411) in subelement Transport 403. The corresponding SGDD informs the receiver of the transport of the group of ESG fragments 413.

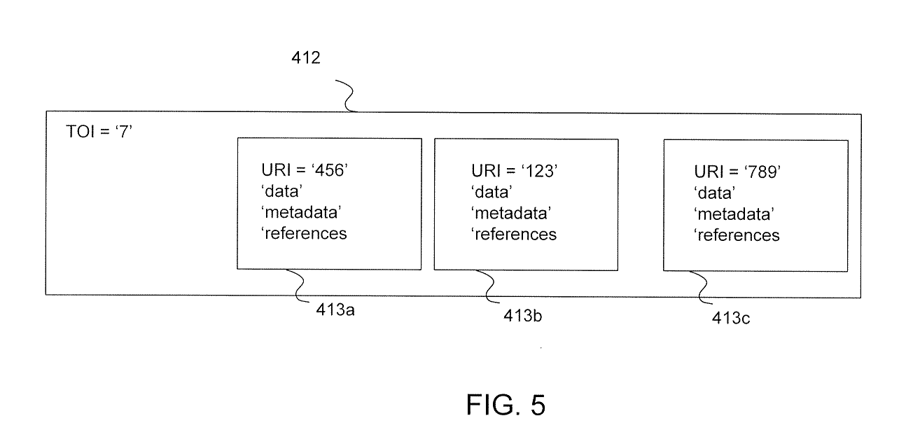

FIG. 5 illustrates an example of components of the SGDU transmitted in a transport object having as identification TOI of FIG. 4. The transport object may carry the TOI in its header, for example, so that different transport objects can be identified. As illustrated in FIGS. 4 and 5, transport object 412 is declared within SGDU 405 and carries ESG fragments (413a, 413b, and 413c in this example). Also in this example, the ESG fragments (413a, 413b, and 413c) carry a URI as identification. Each of the ESG fragments (413a, 413b, and 413c) specify a URI and corresponding data. For example, ESG fragment 413a has a URI of 456 and is mapped to the attribute of “id” 414a of the ESG fragment 413a in the SGDU 405. Examples of methods are provided in detail below.

In one example of the present invention, ESG fragments from the same or different sources may be identified by corresponding Uniform Resource identifiers (URI). A corresponding ID (e.g., “frag_id”) and/or a version (e.g., “frag_version”) can be stored for each corresponding ESG fragment based on previously allocated ESG fragments and corresponding previously allocated IDs and versions. Thus, a SGDU can be created based on the values of the ID and/or version of the ESG fragments.

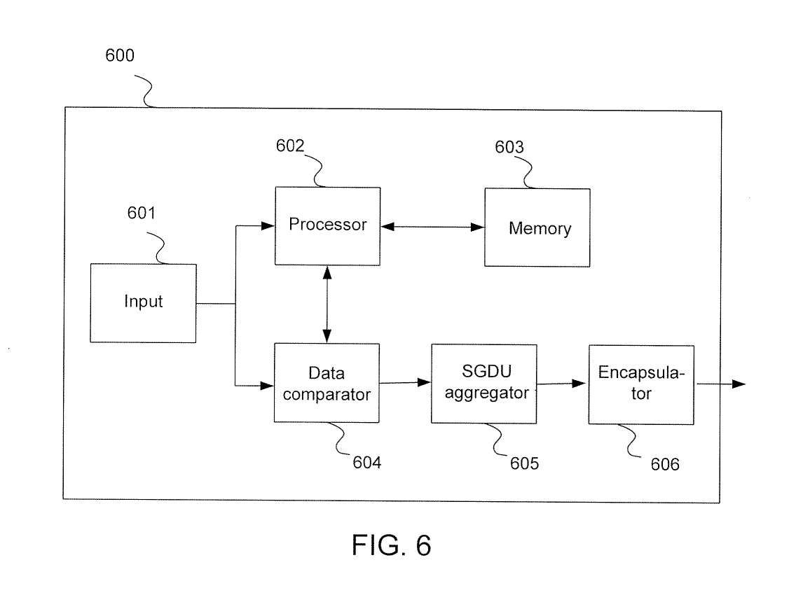

FIG. 6 is a block diagram illustrating an example of a transmitter in accordance with embodiments of the invention. In this example, the transmitter 600 contains an input 601. The input 601 may be configured to receive data and/or metadata or other information that shall be transmitted as an ESG fragment or transmitted using the ESG fragment transportation mechanism. The input 601 may in some embodiment of the invention receive a complete ESG fragment. The transmitter 600 may further include a processor 602 for processing the ESG fragment containing said data, metadata and/or other information received at the input 601. For example, the processor 602 may process the ESG fragment formed from received data at the input 601 to determine the URI, ID or version of the ESG fragment. The processor 602 may also access a memory 603 for determining if any received data is previously stored in memory 603 of the transmitter 600. For example, the processor 602 may access the memory 603 to determine if a version, ID or URI of a previously formed ESG fragment is stored therein. A data comparator 604 in the transmitter 600 may also be used to compare the received data received at the input 601 from stored data in the memory 603. Depending on the results of the data comparison by the data comparator 604, data such as ID, version or URI may be stored in memory 603. Also, an SGDU may be created by the SGDU aggregator 605. Examples of methods for data comparison are provided in detail below. The encapsulator 606 can encapsulate the received ESG fragment into the SGDU created by the SGDU aggregator 605 and send the data to a receiver.

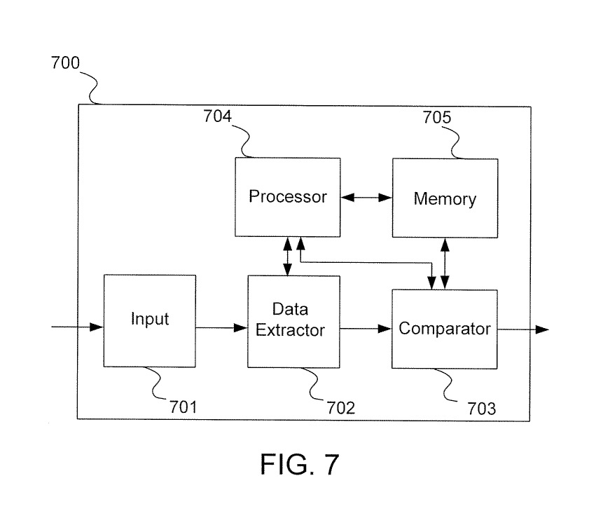

FIG. 7 is a block diagram illustrating an example of a receiver in accordance with embodiments of the invention. In this example, a receiver 700 contains an input 701 for receiving an SGDU from a transmitter. A processor 704 can be used to control the extraction of data from the SGDU received at the input 701. For example, the processor 704 can control a data extractor 702 that can extract information such as an ID or a version of the ESG fragment within the SGDU received at the input 701. The processor may further access a memory 705 to obtain stored information pertaining to previous ESG fragments. For example, the memory 705 may obtain previously stored versions, IDs or URIs from previous ESG fragments and compare these values with the received data. In one example, the version of the received data can be compared with a stored version corresponding to a received ID by a comparator 703. Also, an ID of received data can be compared to previously stored ID information corresponding to a received SGDU. Based on the results from the comparator 703, the data of the ESG fragment can be parsed or interpreted in the receiver 700. Examples of methods of data comparison are provided in detail below.

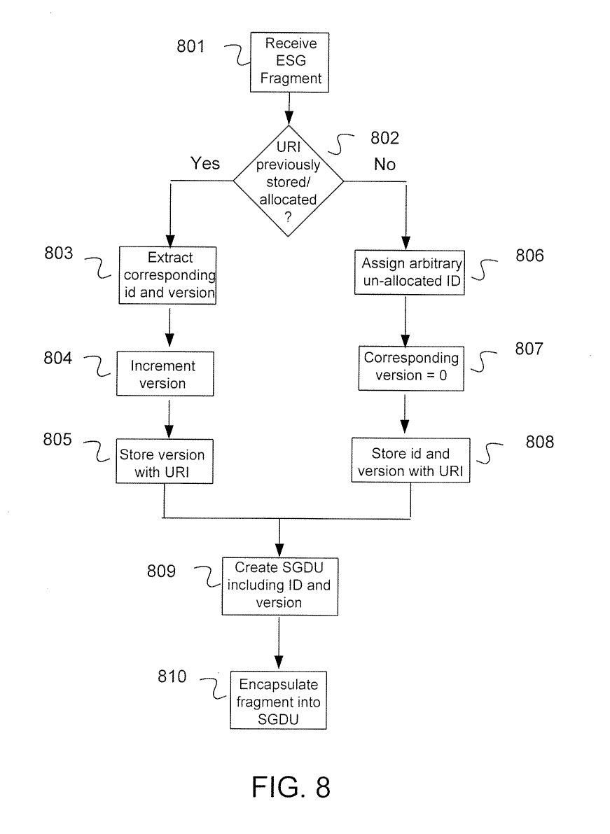

FIG. 8 illustrates an example of a method for mapping a URI and ID according to aspects of the present invention. In this example, an ESG fragment is received (STEP 801). The received ESG fragment is examined at an aggregation device at the transmitter prior to transmission to a receiver. For example, in STEP 802, the URI associated with ESG fragment is examined and compared to previously stored URIs of previous ESG fragments. If the URI is identified in storage (the “YES” branch of step 802), the ID and version values associated with the URI are extracted (STEP 803). The value of the version is incremented (STEP 804) and stored into memory (STEP 805) with the corresponding URI. However, if a matching URI is not found in storage (the “NO” branch of STEP 802), then an arbitrary ID is assigned to the ESG fragment (STEP 806). This arbitrary fragment is selected to be a previously un-allocated ID such that the ID is not already used or stored at the transmitter. The value of the version corresponding to the selected un-allocated ID is set to “0” (STEP 807) and stored with the selected un-allocated ID with the URI (STEP 808).

The ID and version thus obtained are used to create an SGDU (STEP 809). The ESG fragment received in step 801 is encapsulated into the SGDU that is created (STEP 810) and transmitted to a receiver.

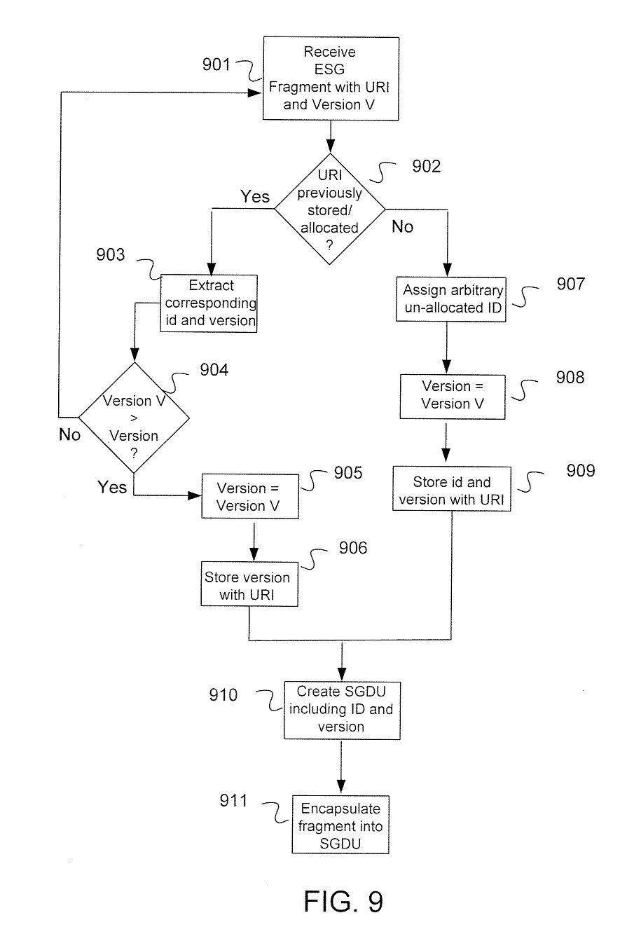

In an alternate method for mapping a URI and ID, a version associated with a received ESG fragment is compared to a stored version corresponding to the URI of the received ESG. FIG. 9 is a flowchart illustrating this example. In this example, an ESG fragment with a corresponding URI and a version (Version “V”, in this example) is received (STEP 901). The URI of the received ESG fragment is compared to stored URIs of previously allocated ESG fragments. If a match is found (the “YES” branch of STEP 902), then an ID and version associated with the stored URI is extracted from memory (STEP 903). The version V (version of the ESG fragment received) is compared to the version extracted from memory corresponding to the previously stored URI. If the value of the version of the ESG fragment received is greater than the stored version value, then the version of the ESG fragment is a more recent version. Thus, the version of the ESG fragment is set to Version V (STEP 905) and stored with the corresponding URI (STEP 906). However, if a match of the URI corresponding to the received ESG fragment is not found (the “NO” branch of STEP 902), then an arbitrary ID is selected and assigned to the ESG fragment (STEP 907). This selected ID is an ID that has not previously been allocated or stored. Because a match is not found in this example, the version is set to Version V (the version of the received ESG fragment) in STEP 908. The version (now set to Version V) is stored with the corresponding ID and URI.

The ID and version thus obtained are used to create an SGDU (STEP 910). The ESG fragment received in step 901 is encapsulated into the SGDU that is created (STEP 911) and transmitted to a receiver.

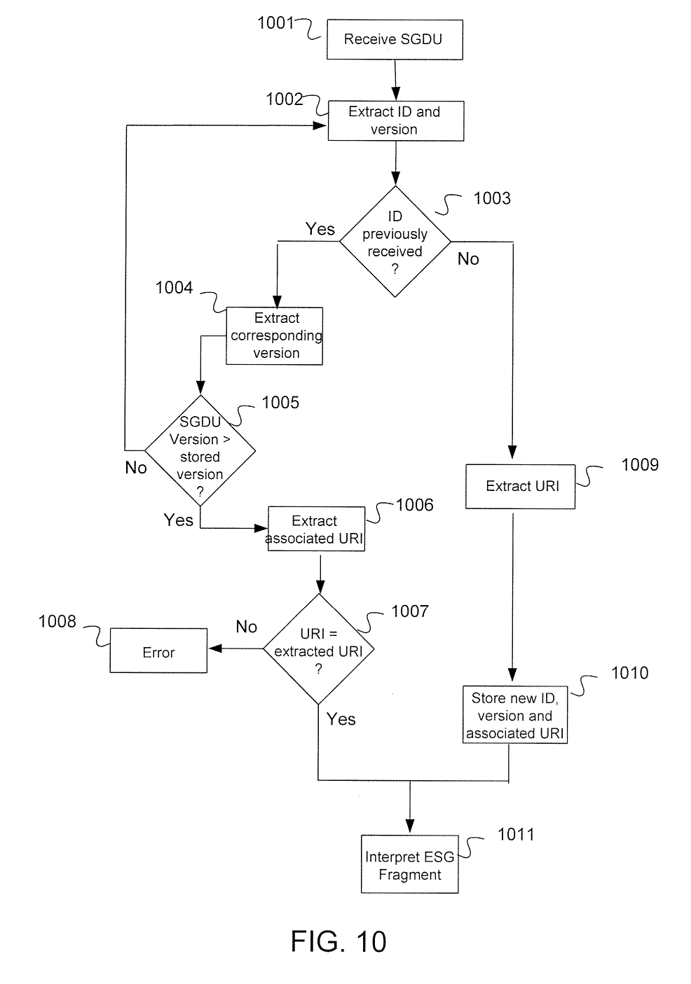

In another example of the present invention, a method for mapping URI and ID values of ESG fragments is provided during receiving of the fragments. FIG. 10 is a flowchart illustrating receiving an SGDU and interpreting an associated ESG fragment. In this example, an SGDU is received (STEP 1001) from a transmitter. The receiver extracts ID and version information from the SGDU in STEP 1002 for example from the binary header of the SGDU and compares the extracted ID data with previously stored/allocated ID data. If a match is found (the “YES” branch of STEP 1003), then a version corresponding to the stored ID is obtained from storage. If the value of the version obtained from the received SGDU is greater than the value of the version extracted from storage (the “YES” branch of step 1005), then the URI associated with the ID of the stored data (i.e., version and ID) is obtained from memory (STEP 1006) and compared with the ID extracted from the SGDU (STEP 1007). If a match of the URIs is found (the “YES” branch of step 1007), then the ESG fragment may be processed. For example, the ESG fragment may parsed by the receiver or otherwise processed (e.g., interpreted). Also, data pertaining to the ESG fragment is kept and maintained in the storage or memory using, for example, the URI or ID (e.g., frag_id) as the key.

However, if after extraction of the ID and version from the received SGDU (STEP 1002), a match is not found between the ID of the received SGDU and the IDs in storage (the “NO” branch of STEP 1003), then the receiver extracts the URI from the received SGDU (STEP 1009) and stores the new ID and version (e.g., frag_id and frag version, respectively) with the associated URI (STEP 1010). The receiver can then process the ESG fragment (e.g., parse or otherwise interpret the ESG fragment and maintain data in storage such as URI or ID data) (STEP 1011).

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

1. An apparatus comprising:
a memory for storing at least one of an identifier (“ID”), version or uniform resource identifier (“URI”) associated with an electronic service guide (“ESG”) fragment;
an input for receiving data to be included in an ESG fragment for transmission, the ESG fragment for transmission having a corresponding ID and version;
a data comparator for comparing at least one of a URI, ID or version associated with the ESG fragment for transmission with a corresponding value associated with the data stored in memory;
an aggregator for creating a service guide delivery unit (“SGDU”) associated with one or more ESG fragments for transmission; and
an encapsulator for encapsulating the one or more ESG fragments for transmission in the SGDU.

2. An apparatus comprising:
a memory for storing at least one of an identifier (“ID”), version or uniform resource identifier (“URI”) associated with an ESG fragment;
an input for receiving a service guide delivery unit (“SGDU”) associated with at least one ESG fragment, the at least one ESG fragment having a corresponding ID and version;
a data extractor for obtaining the at least one of an ID, version, or URI associated with the at least one ESG fragment; and
a comparator for comparing the extracted at least one of an ID, version or URI associated with the at least one ESG fragment with a corresponding value associated with the data stored in memory.

3. A method comprising:
receiving data to be included in an electronic service guide (“ESG”) fragment, the ESG fragment having an associated uniform resource identifier (“URI”);
comparing the URI with a list of at least one stored URI, the list of at least one stored URI comprising URIs associated with previously received ESG fragments;
assigning an identifier (“ID”) and a version to the ESG fragment based on the comparing step;
creating a service guide delivery unit (“SGDU”) associated with one or more ESG fragments for transmission;
encapsulating the one or more ESG fragments into the SGDU; and
transmitting the SGDU containing the one or more ESG fragments.

4. The method of claim 3 wherein the assigning step comprises:
obtaining at least one of an ID and a version corresponding to the stored URI based on the comparing step;
incrementing the value of the version; and
storing the incremented value of the version with the URI corresponding to the ESG fragment.

5. The method of claim 3 wherein the assigning step comprises:
assigning an arbitrary ID to the ESG fragment based on the comparing step;
assigning a value of 0 to the value corresponding to the ESG fragment; and
storing the assigned arbitrary ID and the value with the associated URI corresponding to the ESG fragment.

6. The method of claim 3 wherein the assigning step comprises:
obtaining at least one of an ID and a version corresponding to the stored URI if the stored URI matches the URI corresponding to the ESG fragment, otherwise obtaining an arbitrary value for an ID corresponding to the ESG fragment;
incrementing the value of the version if the stored URI matches the URI corresponding to the ESG fragment in the comparing step, otherwise assigning a value of 0 to the value associated with the ESG fragment; and
storing the incremented value of the version with the URI corresponding to the ESG fragment.

7. A method comprising:
receiving data to be included in an electronic service guide (“ESG”) fragment, the ESG fragment having an associated uniform resource identifier (“URI”) and a version;
comparing the URI with a list of at least one stored URI, the list of at least one stored URI comprising URIs associated with previously received ESG fragments;
assigning an identifier (“ID”) and a version to the ESG fragment based on the comparing step;
creating a service guide delivery unit (“SGDU”) associated with one or more ESG fragments for transmission;
encapsulating the one or more ESG fragments into the SGDU; and
transmitting the SGDU containing the one or more ESG fragments.

8. The method of claim 7 wherein the assigning step comprises:
obtaining an ID and a version corresponding to a stored URI based on the comparing step;
comparing the version associated with the ESG fragment with the version corresponding to the stored URI; and
storing the version associated with the ESG fragment if the version associated with the ESG fragment is greater than the value corresponding to the stored URI.

9. The method of claim 7 wherein the assigning step comprises:
assigning an arbitrary ID to the ESG fragment based on the comparing step; and
storing the arbitrary ID and the value of the version associated with the ESG fragment with the corresponding URI associated with the ESG fragment.

10. The method of claim 7 wherein the assigning step comprises
obtaining an ID and a version corresponding to a stored URI if the stored URI matches the URI corresponding to the ESG fragment, otherwise obtaining an arbitrary value for an ID corresponding to the ESG fragment; and
comparing the version associated with the ESG fragment with the version corresponding to the stored URI and storing the version associated with the ESG fragment if the version associated with the ESG fragment is greater than the value corresponding to the stored URI and the stored URI matches the URI corresponding to the ESG fragment, otherwise storing the arbitrary ID and the value of the version associated with the ESG fragment with the corresponding URI associated with the ESG fragment.

11. A method comprising:
receiving a service guide delivery unit (“SGDU”) including at least one ESG fragment;
extracting an identifier (“ID”) and version associated with the SGDU;
comparing the ID associated with the SGDU with a stored ID;
extracting a URI from the SGDU; and
processing the at least one ESG fragment based on the comparing step.

12. The method of claim 11 wherein the processing step comprises:
comparing the version associated with the SGDU with a version associated with the stored ID;
extracting a URI associated with the stored ID if the version associated with the SGDU is greater than the version associated with the stored ID; and
processing the ESG fragment if the URI associated with the stored ID is equal to the URI from the SGDU, otherwise generating an error message.

13. The method of claim 11 wherein the processing step comprises:
storing the ID and version associated with the SGDU with the URI from the SGDU; and
interpreting the ESG fragment.

14. The method of claim 11 wherein the processing step comprises extracting a version and a URI associated with the stored ID if the ID associated with the SGDU matches the stored ID and the version associated with the SGDU is greater than the version associated with the stored ID.

15. The method of claim 14 wherein the processing step comprises processing the ESG fragment if the URI associated with the stored ID is equal to the URI associated with the SGDU.

16. An apparatus comprising:
means for receiving data to be included in an electronic service guide (“ESG”) fragment, the ESG fragment having an associated uniform resource identifier (“URI”);
means for comparing the URI with a list of at least one stored URI, the list of at least one stored URI comprising URIs associated with previously received ESG fragments;
means for assigning an identifier (“ID”) and a version to the ESG fragment based on the comparing step;
means for creating a service guide delivery unit (“SGDU”) associated with one or more ESG fragments for transmission;
means for encapsulating the one or more ESG fragments into the SGDU; and
means for transmitting the SGDU containing the one or more ESG fragments.

17. The apparatus of claim 16 wherein the means for assigning comprises:
means for obtaining at least one of an ID and a version corresponding to the stored URI based on the comparing step;
means for incrementing the value of the version; and
means for storing the incremented value of the version with the URI corresponding to the ESG fragment.

18. The apparatus of claim 16 wherein the means for assigning comprises:
means for assigning an arbitrary ID to the ESG fragment based on the comparing step;
means for assigning a value of 0 to the value corresponding to the ESG fragment; and
means for storing the assigned arbitrary ID and the value with the associated URI corresponding to the ESG fragment.

19. The apparatus of claim 16 wherein the means for assigning comprises:
means for obtaining at least one of an ID and a version corresponding to the stored URI if the stored URI matches the URI corresponding to the ESG fragment, otherwise obtaining an arbitrary value for an ID corresponding to the ESG fragment;
means for incrementing the value of the version if the stored URI matches the URI corresponding to the ESG fragment in the comparing step, otherwise assigning a value of 0 to the value associated with the ESG fragment; and
means for storing the incremented value of the version with the URI corresponding to the ESG fragment.

20. An apparatus comprising:
means for receiving data to be included in an electronic service guide (“ESG”) fragment, the ESG fragment having an associated uniform resource identifier (“URI”) and a version;
means for comparing the URI with a list of at least one stored URI, the list of at least one stored URI comprising URIs associated with previously received ESG fragments;
means for assigning an identifier (“ID”) and a version to the ESG fragment based on the comparing step;
means for creating a service guide delivery unit (“SGDU”) associated with one or more ESG fragments for transmission;
means for encapsulating the one or more ESG fragments into the SGDU; and
means for transmitting the SGDU containing the one or more ESG fragments.

21. The apparatus of claim 20 wherein the means for assigning comprises:
means for obtaining an ID and a version corresponding to a stored URI based on the comparing step;
means for comparing the version associated with the ESG fragment with the version corresponding to the stored URI; and
means for storing the version associated with the ESG fragment if the version associated with the ESG fragment is greater than the value corresponding to the stored URI.

22. The apparatus of claim 20 wherein the means for assigning comprises:
means for assigning an arbitrary ID to the ESG fragment based on the comparing step; and
means for storing the arbitrary ID and the value of the version associated with the ESG fragment with the corresponding URI associated with the ESG fragment.

23. The apparatus of claim 20 wherein the means for assigning comprises
means for obtaining an ID and a version corresponding to a stored URI if the stored URI matches the URI corresponding to the ESG fragment, otherwise obtaining an arbitrary value for an ID corresponding to the ESG fragment; and
means for comparing the version associated with the ESG fragment with the version corresponding to the stored URI and storing the version associated with the ESG fragment if the version associated with the ESG fragment is greater than the value corresponding to the stored URI and the stored URI matches the URI corresponding to the ESG fragment, otherwise storing the arbitrary ID and the value of the version associated with the ESG fragment with the corresponding URI associated with the ESG fragment.

24. An apparatus comprising:
means for receiving a service guide delivery unit (“SGDU”) including at least one electronic service guide (“ESG”) fragment;
means for extracting an identifier (“ID”) and version associated with the SGDU;
means for comparing the ID associated with the SGDU with a stored ID;
means for extracting a URI from the SGDU; and
means for processing the at least one ESG fragment based on the comparing step.

25. The apparatus of claim 24 wherein the means for processing comprises:
means for comparing the version associated with the SGDU with a version associated with the stored ID;
means for extracting a URI associated with the stored ID if the version associated with the SGDU is greater than the version associated with the stored ID; and
means for processing the ESG fragment if the URI associated with the stored ID is equal to the URI from the SGDU, otherwise generating an error message.

26. The apparatus of claim 24 wherein the means for processing comprises:
means for storing the ID and version associated with the SGDU with the URI from the SGDU; and
means for interpreting the ESG fragment.

27. The apparatus of claim 24 wherein the means for processing comprises means for extracting a version and a URI associated with the stored ID if the ID associated with the SGDU matches the stored ID and the version associated with the SGDU is greater than the version associated with the stored ID.

28. The apparatus of claim 27 wherein the means for processing comprises means for processing the ESG fragment if the URI associated with the stored ID is equal to the URI associated with the SGDU.
